(19) United States
(12) Patent Application Publication
(10) Pub. No.: US 2024/0390972 A1
(43) Pub. Date: Nov. 28, 2024

(54) ROTARY DEVICE FOR TREATING MOLTEN METAL

(71) Applicant: FOSECO INTERNATIONAL LIMITED, Barlborough Links, Derbyshire (GB)

(72) Inventors: Nagendra NAG, Bridgeville, PA (US); Wenwu SHI, Arlington, MA (US)

(21) Appl. No.: 18/694,332

(22) PCT Filed: Sep. 20, 2022
(86) PCT No.: PCT/EP2022/076133

§ 371 Date: Mar. 21, 2024

(30) Foreign Application Priority Data
Sep. 21, 2021 (EP) 21197933.1

(51) Int. Cl. B22D 1/00

(52) U.S. Cl. CPC B22D 1/002

(57) ABSTRACT

The invention relates to a rotary device for treating molten metal and a rotor for use with the rotary device. The rotary device comprises a hollow shaft and a rotor at one end of the hollow shaft, the rotor comprising: a roof and a base, the roof and base being spaced apart and connected by a plurality of dividers; a central chamber defined between the roof and the base, the dividers extending radially from the periphery of the central chamber; a passage being defined between each adjacent pair of dividers, each passage having an inlet located radially outward of the central chamber and an outlet in an outer peripheral surface of the rotor; and a flow path being defined through the hollow shaft into the central chamber, through the inlets of the passages and out of the outlets. The base comprises either: a plurality of apertures fluidly connected to the central chamber and a radial blade defined between each adjacent pair of apertures; a central aperture and a plurality of radial vanes protruding outwardly from the base, the radial vanes being arranged around the periphery of the central aperture, wherein the radial vanes extend towards the centre of the base and at least partially over the central aperture; or a central aperture and a plurality of radial vanes protruding outwardly from the base, the radial vanes being arranged around the periphery of the central aperture, wherein the base further comprises a plurality of cut-outs arranged between the radial vanes, the cut-outs in the base extending inwardly from the outer periphery of the rotor.

### TECHNICAL FIELD

The present invention relates to a rotary device for treating molten metal. In particular, the present invention relates to a rotary device for removing unwanted impurities from molten metal, such as dissolved gas and solid inclusions.

### BACKGROUND

For casting applications (in particular casting of non-ferrous metals such as aluminium or aluminium alloy), the molten metal must be treated before casting—typically by one or more of the following processes:
i) Degassing—The presence of dissolved gas in molten metal can introduce defects in the solidified product and may detrimentally affect its mechanical properties. For example, hydrogen has a high solubility in liquid aluminium which increases with melt temperature, but its solubility in solid aluminium is very low. Consequently, as the aluminium cools, hydrogen gas is expelled which can create gas pores in the solidified casting. The rate of solidification influences the amount and size of the bubbles. In certain applications, the pinhole porosity may seriously affect the mechanical strength and pressure tightness of the metal casting. Gas may also diffuse into voids and discontinuities (e.g. oxide inclusions) which can result in blister formation during the production of plates, sheets and strips made from aluminium or aluminium alloy.
ii) Grain refinement—The mechanical properties of the casting can be improved by controlling the grain size of the solidifying metal. The grain size of a cast metal is dependent on the number of nuclei present in the liquid metal as it begins to solidify and on the rate of cooling. A faster cooling rate generally promotes a smaller grain size and additions of certain elements to the melt can provide additional nuclei for grain growth.
iii) Modification—The microstructure and properties of metal alloys can be improved by the addition of small quantities of certain ‘modifying’ elements such as sodium or strontium. Modification increases hot tear resistance and improves alloy feeding characteristics, decreasing shrinkage porosity.
iv) Cleaning and alkali removal—Significant concentration of alkali elements can have an adverse effect on alloy properties, and so these alkali elements need to be removed or reduced. For example, the presence of calcium in casting alloys can interfere with other treatment processes such as modification, while excess concentrations of sodium can have a deleterious effect on the ductile properties of wrought aluminium alloys. The presence of non-metallic inclusions such as oxides, carbides and borides entrained in the solidified metal can also adversely affect the physical and mechanical properties of the metal, and so these also need to be removed.

The above treatment processes may be carried out individually or simultaneously by a variety of methods and equipment.

Degassing of molten metal is typically conducted using a rotary degassing unit (“RDU”), which flushes the molten metal with fine bubbles of a dry inert gas, such as chlorine, argon, nitrogen or mixtures thereof. The RDU typically comprises a hollow shaft to which a rotor is attached. In use, the shaft and rotor are rotated and gas is passed down the shaft and dispersed into the molten metal via the rotor. Introducing the gas through a rotor generates a large number of very fine bubbles, which are dispersed through to the bottom of the melt. As these bubbles rise through the melt, hydrogen diffuses into them and is ejected into the atmosphere when the bubbles reach the surface. The rising bubbles also collect solid inclusions and carry them to the top of the melt, where they can be skimmed off. In addition to introducing gas to remove hydrogen (and oxide inclusions), the rotary degassing unit may also be used to inject metal treatment agents into the melt through the shaft together with the inert gas, or through a tube adjacent to the shaft.

An example of a rotary device for use in a rotary degassing unit is the “XSR rotor” (prior art rotor 1) described in WO2004/057045 and shown in FIG. 1. The rotary device 2 comprises a hollow shaft 4 having a bore 4a therethrough, which is connected at one end to a rotor 6. The rotor 6 is generally disc-shaped and comprises an annular upper roof 8 spaced apart from an annular base 10. An open chamber 12 is provided centrally in the base 10 and extends upwardly to the roof 8. The roof 8 and base 10 are connected by four dividers 14 which extend outwardly from the periphery of the chamber 12 to the periphery of the rotor 6. A compartment 16 is defined between each pair of adjacent dividers 14, the roof 8 and the base 10. The peripheral edge 8a of the roof 8 is provided with a plurality of part-circular cut-outs 18 (in this embodiment, eight cut-outs). Each cut-out 18 serves as a second outlet for its respective compartment 16.

Rotors for treating molten metals, such as aluminium, have traditionally been manufactured by machining a solid block of graphite into the desired shape. However, machining can be a difficult and costly process and is not well suited to producing intricate shapes—particularly on interior surfaces of the rotor, since line-of-sight access is required for the drilling tool. Machining also limits the selection of materials that the rotor can be made from, since the drilling tool may be unable to bore through more durable or more abrasive ceramic materials. Moreover, machining flaws can negatively affect the strength of the manufacturing material and hence the longevity of the rotor.

The inventors of the present invention have found that, by using isostatic pressing to press the manufacturing material around a sacrificial core and then subsequently removing the core, much more complex rotor designs can be produced—particularly on the interior of the rotor, since line-of-sight access is not required. Moreover, this new manufacturing method enables much more durable materials to be used for the rotor, such as alumina, carbon-bonded alumina, or other refractory metal oxides, carbides or nitrides, which would be difficult to shape by machining. By isopressing the rotor around a sacrificial core, the surface finish of the rotor can also be greatly improved, with a very smooth surface and seamless merging between Gaussian and non-Gaussian surface curvatures.

The present invention is therefore aimed at providing completely new and improved rotor designs which were not previously possible to manufacture by conventional methods such as machining, and which may be made from more durable materials.

### SUMMARY OF THE INVENTION

According to a first aspect of the invention, there is provided a rotary device for treating molten metal, the device comprising a hollow shaft and a rotor at one end of the hollow shaft. The rotor comprises: a roof and a base, the roof and base being spaced apart and connected by a plurality of dividers; a central chamber defined between the roof and the base, the dividers extending radially from the periphery of the central chamber; a passage being defined between each adjacent pair of dividers, each passage having an inlet which is located radially outward of the central chamber and an outlet in an outer peripheral surface of the rotor; and a flow path being defined through the hollow shaft into the central chamber, through the inlets of the passages and out of the outlets. The base comprises a plurality of apertures fluidly connected to the central chamber, and a radial blade defined between each adjacent pair of apertures.

It will be understood that the device has a longitudinal axis extending along the length of the hollow shaft, and that the terms “radial” and “radially” as used herein mean extending between the centre of the rotor and an outer periphery of the rotor in a direction perpendicular to the longitudinal axis. The rotor may be generally circular in cross-section, with a radius extending between the centre of the rotor and an outer periphery of the rotor. In general, the roof and the base of the rotor lie in parallel planes which are perpendicular to the longitudinal axis.

The rotor may be integrally formed with the hollow shaft. Alternatively, the rotor may be a discrete component that is attached to the hollow shaft, e.g. screwed on, push-fit or secured by a locking mechanism or adhesive.

In use, the radial blades assist in chopping up bubbles of gas injected through the hollow shaft to producer much smaller and more numerous bubbles. Reducing the size and increasing the number of bubbles improves dispersion of the bubbles throughout the melt, significantly increasing degassing and cleaning efficiency at a given rotation speed and thereby reducing treatment time, or maintaining the same degassing and cleaning efficiency at a lower rotation speed and thereby extending the life of the shaft and rotor. In addition, smaller bubbles may have a lower rising velocity through the melt and thus a longer residual time inside the melt for hydrogen to diffuse into the bubbles.

The plurality of apertures may be located in the centre of the base. The base may be annular. The plurality of apertures may be located axially of the hollow shaft and/or central chamber. In some embodiments, the base of the rotor comprises at least three apertures and at least three radial blades. In some embodiments, the base of the rotor comprises three, four, five or six apertures and radial blades. In some embodiments, the radial blades are equally spaced apart, forming a turbine-like arrangement.

In some embodiments, the radial blades lie in the plane of the base, i.e. not protruding outwardly from the plane of the base. In alternative embodiments, the radial blades do protrude outwardly from the plane of the base. The radial blades may protrude to a height that is less than or equal to the height of the base, as measured in the direction of the longitudinal axis. The radial blades may extend from the base away from the central chamber. In some embodiments, the radial blades do not extend into the region between the base and the roof.

In some embodiments, the radial blades are connected to each other by a central hub, which is located in the centre of the base. The central hub may be circular in shape. The central hub may provide structural support to the radial blades.

In some embodiments, the radial blades are angled relative to the plane of the base and/or the plane normal to the rotational axis of the rotor e.g. obliquely angled. For example, the radial blades may form an impeller. The radial blades may have a blade angle α between 30° and 90°, or between 40° and 80°, between 50° and 70°, or of approximately 60°.

In use, the rotary device may be configured to generate a fluid flow path through the rotor (e.g. a liquid flow path for the molten metal). The fluid flow path may be defined axially through the plurality of apertures to the central chamber, and subsequently radially from the central chamber through the passage between each adjacent pair of dividers. For example, the rotor may be configured to draw in liquid through the base and drive it radially outward. The radial blades may have be obliquely angled relative to the fluid flow path.

In one series of embodiments, the radial blades are positively angled relative to the fluid flow path i.e. they are angled such that rotation of the rotor increases fluid flow in the fluid flow path. This may be desirable in order to increase the fluid flow rate, speed, or volume through the rotor. In such embodiments, the portion of the radial blade closest to the central chamber forms the trailing edge. In other words, the blade is angled upwards.

In a further series of embodiments, the radial blades are configured to slow fluid passing through the base e.g. to slow fluid entering the central chamber through the base. The radial blades may be negatively angled relative to the fluid flow path i.e. they are angled such that rotation of the rotor decreases fluid flow in the fluid flow path. This may be desirable to increase the residence time of the fluid in the rotor and/or to increase the time for the rotor to chop up or disperse the gas bubbles and to prolong the shear forces exerted on the fluids (e.g. either the liquid metal or the gases therein). In such embodiments, the portion of the radial blade closest to the central chamber forms the leading edge. In other words, the blade is angled downwards.

It would be understood that whether the radial blades are positively angled (e.g. upwards) or negatively angled (e.g. downwards) depends on the direction of rotation of the rotor. In the present context, the positive and negative angles are intended to be viewed in relation to the rest of the rotor and the intended direction of rotation of the rotor. For example, in embodiments wherein the radial blades are negatively angled, this is intended to mean relative to the rotation direction determined by the configuration of said rotor e.g. the radial blades may be angled in the opposite direction to other components of the rotor such as the dividers and/or the apertures. In some embodiments, the rotor may be intended to be rotatable in either direction.

According to a second aspect of the invention, there is provided a rotary device for treating molten metal, the device comprising a hollow shaft and a rotor at one end of the hollow shaft. The rotor comprises a roof and a base, the roof and base being spaced apart and connected by a plurality of dividers; a central chamber defined between the roof and the base; a passage being defined between each adjacent pair of dividers, each passage having an inlet located radially outward of the central chamber and an outlet in an outer peripheral surface of the rotor; and a flow path being defined through the hollow shaft into the central chamber, through the inlets of the passages and out of the outlets. The base of the rotor comprises a central aperture and a plurality of radial vanes protruding outwardly from the base, the radial vanes being arranged around the periphery of the central aperture. The radial vanes extend towards the centre of the base and at least partially over the central aperture.

It will be understood that the “centre of the base” is intended to mean a central point as measured along the plane of the base from the outer periphery of the rotor, rather than along the longitudinal axis of the device. The outwardly extending vanes may extend axially and/or from the base in the direction opposite to the central chamber.

In use, the radial vanes extending out at least partially over the central aperture achieve a similar effect to the radial blades in the rotor of the first aspect, i.e. chopping up the bubbles injected through the hollow shaft. In addition, the protruding vanes may increase the torque and directional flow of bubbles achieved by the rotor.

In some embodiments, the base of the rotor comprises at least three apertures and at least three radial vanes. In some embodiments, the base of the rotor comprises three, four, five, six, seven or eight radial vanes. It will be understood that increasing the number of vanes increases the complexity of manufacture and reduces the cross-sectional area of each vane, and so these factors must be balanced with rotor performance.

According to a third aspect of the invention, there is provided a rotary device for treating molten metal, the device comprising a hollow shaft and a rotor at one end of the hollow shaft. The rotor comprises a roof and a base, the roof and base being spaced apart and connected by a plurality of dividers; a central chamber defined between the roof and the base; a passage being defined between each adjacent pair of dividers, each passage having an inlet located radially outward of the central chamber and an outlet in an outer peripheral surface of the rotor; and a flow path being defined through the hollow shaft into the central chamber, through the inlets of the passages and out of the outlets. The base of the rotor comprises a central aperture and a plurality of radial vanes protruding outwardly from the base, the radial vanes being arranged around the periphery of the central aperture. The base further comprises a plurality of cut-outs arranged between the radial vanes, the cut-outs in the base extending inwardly from the outer periphery of the rotor towards the centre of the base.

In use, the cut-outs in the base achieve a similar effect to the radial blades in the rotor of the first aspect, i.e. chopping up the bubbles injected through the hollow shaft. The radial vanes may increase the torque and directional flow of bubbles achieve by the rotor. In addition, the cut-outs in the base may also increase the torque and directional flow of bubbles achieve by the rotor.

In some embodiments, the base comprises at least three cut-outs. In some embodiments, the base comprises three, four, five or six cut-outs.

In some embodiments, the edge of each cut-out in the base is pitched at an angle relative to the plane of the base and/or to a plane normal to the axis of rotation. In some embodiments, the edge of each cut-out in the base is pitched at an angle of 20° to 70° relative to the plane of the base. Pitching the edge of each cut-out at an angle into the intended direction of rotation may help to reduce the drag coefficient as the rotor spins in the melt, reducing the amount of stirring power required for a given rotation velocity. Pitching the edge of each cut-out may also improve the ease of manufacturing by iso-pressing.

In some embodiments, the cut-outs in the base are part-circular or semi-circular in cross section (i.e. an axial cross section through the cut-outs). The cross-section may be normal to the axis of rotation. In some such embodiments, the edge of each cut-out may be pitched at an angle relative to the plane of the base, with the pitch angle varying along the length of the edge. In some embodiments, one end of the edge is pitched at an angle of 20° to 70°, while the other end of the edge is pitched at an angle of 110° to 160°.

The cut-outs in the base extending inwardly from the outer periphery of the rotor towards the centre of the base. In some embodiments, the cut-outs extend inwardly at least 5%, at least 10%, at least 20%, at least 30% or at least 40% of the radius of the rotor. In some embodiments, the cut-outs extend inwardly no more than 50%, no more than 40%, no more than 30%, no more than 20% or no more than 10% of the radius of the rotor. In some embodiments, the cut-outs extend inwardly to from 5 to 50% of the radius of the rotor.

In some embodiments, the radial vanes are a continuation of the dividers through the base.

In some embodiments, the radial vanes are tapered such that the width of each vane decreases from the outer periphery of the rotor to the central aperture.

The following optional features may apply equally to any embodiment of the first, second or third aspects of the invention described above.

In some embodiments, the radial blades or vanes are symmetrically arranged. In some embodiments, the radial blades or vanes are equally spaced apart from each other.

In some embodiments, the radial blades or vanes are pitched at an angle relative to the plane of the base. In some embodiments, the radial blades or vanes are pitched at an angle of 20° to 70° relative to the plane of the base. In some embodiments, the radial blades or vanes are curved. In some embodiments, the radial blades or vanes are both curved and pitched at an angle relative to the plane of the base. Pitching the blades/vanes at an angle or curving the blades/vanes into the intended direction of rotation may help to reduce the drag coefficient as the rotor spins in the melt, reducing the amount of stirring power required for a given rotation velocity.

In some embodiments, the rotor comprises at least four dividers and at least four passages defined therebetween, or at least six dividers and at least six passage defined therebetween. In some embodiments, the rotor comprises four divider and four passages, five dividers and five passages, six dividers and six passages, seven dividers and seven passages, or eight dividers and eight passages.

In some embodiments, the dividers are oriented perpendicular to the plane of the base. Alternatively, the dividers may be oriented at an angle relative to the plane of the base. In some embodiments, the dividers are oriented at an angle of 20° to 70° relative to the plane of the base.

The dividers may extend axially between the base and roof. Optionally, the dividers do not extend beyond the base. The dividers may be spaced apart from the plurality of apertures and/or radial blades in the base. In embodiments comprising vanes extending from the base, the dividers may extend from the base in the opposite direction to the vanes.

In some embodiments, each passage comprises a second outlet in the roof of the rotor. The second outlet may disperse gas upwardly from the rotor in use. Providing a combination of laterally directed and upwardly directed outlets has been found to allow smaller and more numerous bubbles of gas to be created, increasing degassing and cleaning efficiency, as discussed in the applicant's previous patent EP1573077.

In some embodiments, each second outlet is a cut-out extending inwardly from the outer periphery of the roof. The cut-out may be part-circular or semi-circular in cross-section.

In some embodiments, the cut-out extends inwardly at least 5%, at least 10%, at least 20%, at least 30% or at least 40% of the radius of the rotor. In some embodiments, the cut-out extends inwardly no more than 50%, no more than 40%, no more than 30%, no more than 20% or no more than 10% of the radius of the rotor. In some embodiments, the cut-out extends inwardly from 5 to 50% of the radius of the rotor.

In some embodiments, the cut-outs in the roof extend through the roof at an perpendicular to the plane of the roof. In some embodiments, the cut-outs in the roof extend through the roof at an angle relative to the plane of the roof. In some embodiments, the cut-outs in the roof extend through the roof at an angle of 20° to 70° relative to the plane of the roof. In some embodiments, the cut-outs in the roof extend through the roof at an angle of 110° to 160° relative to the plane of the roof. In embodiments where the dividers and/or the radial vanes/blades are oriented at an angle relative to the plane of the base, the cut-outs may extend through the roof at the same angle or at an opposite angle to either the angle of the dividers and/or the angle of the radial vanes/blades.

In some embodiments, an inner surface of the roof comprises a groove extending between the central chamber and at least one second outlet. The groove may allow a portion of the gas injected through the shaft to be more efficiently channeled to the second outlet.

In some embodiments, the roof of the rotor is provided with a central bore therethrough, such that gas can be injected through from the hollow shaft to the central chamber of the rotor.

In some embodiments, an inner surface of the roof comprises an interior flow-directing member for channeling gas bubbles in the roof down into the central chamber and towards the base of the rotor. In some embodiments, the flow-directing member comprises an annular wall. In some embodiments, the annular wall extends around the circumference of the central bore in the roof. The annular wall may be tapered such that it is widest at the roof and narrows as it extends towards the base of the rotor. In some embodiments, the annular wall comprises a plurality of open channels which extend generally in a direction between the roof and the base. The channels may be curved so as to impart a downward spiral flow pattern on bubbles from the roof.

In some embodiments, the roof and the base of the rotor are generally disc-shaped.

In some embodiments, the rotor is made from an isostatic pressed refractory material. Any refractory material which is suitable for iso-pressing may be used, such as refractory mixtures comprising metal oxides, carbides, or nitrides. In some embodiments, the rotor is made from graphite, alumina, alumina silicate, carbon-bonded alumina, carbon-bonded ceramics, clay-bonded graphite, silicon alumina nitride, fused silica, silicon carbide, zirconia, or any mixture thereof.

According to a fourth aspect of the invention, there is provided a rotor for use in the rotary device of any embodiment of the first, second or third aspects. Any of the optional features described above in relation to the first, second or third aspects may be freely combined with the rotor of the fourth aspect, where applicable.

In some embodiments, the roof of the rotor is provided with engagement means for attachment to the hollow shaft of the device. The engagement means may comprise a threaded wall which allows the rotor to be screwed onto a complementary thread on an end of the hollow shaft. Alternatively, the engagement means may comprise a cavity in the roof of the rotor which is configured to have a complementary size and shape to an end of the hollow shaft, such that the rotor can attach to the hollow shaft by a push-fit mechanism or using a suitable refractory adhesive such as expanding refractory foam adhesive (for example, Cera Foam produced by ZYP Coatings, Inc). Alternatively, the engagement means may comprise a locking mechanism.

It will be understood that the rotors disclosed herein are not limited to any particular manufacturing method and may be formed by any suitable method, e.g. by isopressing around a sacrificial core and then removing the core, additive manufacturing, etc.

### BRIEF DESCRIPTION OF THE DRAWINGS

FIG. 1 shows a prior art rotor as described in WO2004/057045;

FIGS. 2a-c show an embodiment of a rotor for use with the first aspect of the invention;

FIG. 3 shows another embodiment of a rotor for use with the first aspect of the invention:

FIG. 4 shows an embodiment of a rotor for use with the second aspect of the invention;

FIG. 5 shows an embodiment of a rotor for use with the third aspect of the invention

FIG. 6 is a graph comparing the torque of three different rotor designs;

FIG. 7 is a chart comparing the change in water surface level;

FIG. 8 shows three graphs comparing the mixing efficiency of three different rotor designs;

FIG. 9 is a graph comparing the degassing efficiency;

FIGS. 10a-c show three graphs comparing the effect of various different features on degassing efficiency;

FIG. 11 is a graph comparing the bubble mass transfer of five different rotor designs;

FIG. 12 is a graph comparing the surface mass transfer of five different rotor designs;

FIGS. 13a-b show two graphs comparing the degassing efficiency of five different rotor designs; and

FIG. 14 is a graph comparing the degassing efficiency of two rotor designs.

### DETAILED DESCRIPTION OF EMBODIMENTS

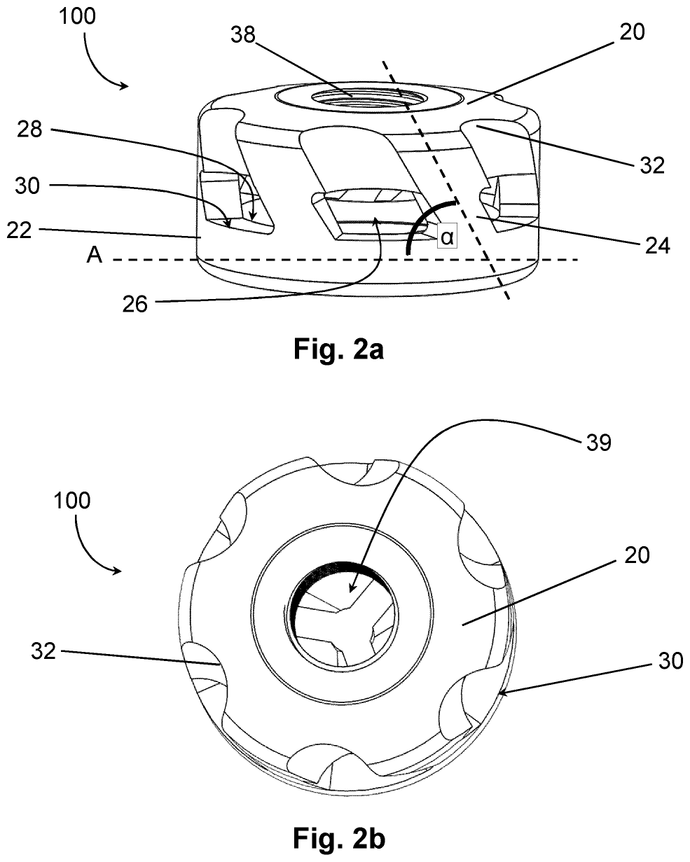

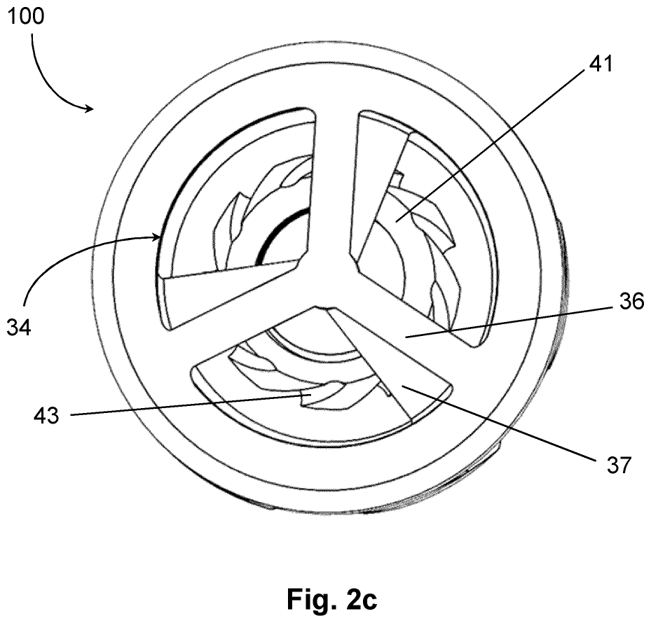

FIGS. 2a-c show three different perspective views of a rotor 100 for use with the first aspect of the invention. The rotor 100 comprises a roof 20 and a base 22, spaced apart by a plurality of dividers 24 (in the illustrated embodiment, six dividers). The dividers 24 extend radially from the periphery of a central chamber 26 defined between the roof 20 and the base 22. The roof 20 and the base 22 are generally disc-shaped.

A passage is defined between each adjacent pair of dividers 24, with each passage having an inlet 28 located radially outward of the central chamber 26 and a first outlet 30 in an outer peripheral surface of the rotor 100. The first outlets direct flow laterally from the rotor. Each passage also has a second outlet 32 in the roof 20. The second outlets 32 directs flow upwardly from the rotor. Each second outlet 32 is a part-circular cut-out in the roof 20, extending inwardly from the outer periphery of the rotor 100. The second outlets 32 are smaller in width than the first outlets 30.

The base 22 comprises three apertures 34 fluidly connected to the central chamber 26. Each adjacent pair of apertures 34 defines a radial blade 36 therebetween. In the illustrated embodiment, the base 22 comprises three radial blades 36 equally spaced apart in a turbine arrangement, with the radial blades 36 lying in the plane of the base A.

An edge 37 of each radial blade 36 is pitched at an angle α relative to the plane of the base. In the illustrated embodiment, the angle α is 60°. The dividers 24 and the second outlets 32 are also oriented at the same angle α relative to the plane of the base A.

The roof 20 of the rotor 100 comprises a central bore 39 and engagement means for attachment to a hollow shaft. In the illustrated embodiment, the engagement means comprises a female threaded wall 38 for screwing onto a male threaded end of the hollow shaft. An inner surface of the roof 20 comprises a flow-directing member for channeling gas bubbles in the roof 20 down into the central chamber 26. In the illustrated embodiment, the flow-directing member comprises an annular wall 41 which extends around the circumference of the central bore 35. The annular wall 41 is tapered such that it is widest at the roof 20 and narrows as it extends towards the base 22. The annular wall 41 comprises a plurality of open channels 43 which extend generally in a direction between the roof 20 and the base 22 and are curved so as to impart a downward spiral flow pattern on bubbles in the roof 20.

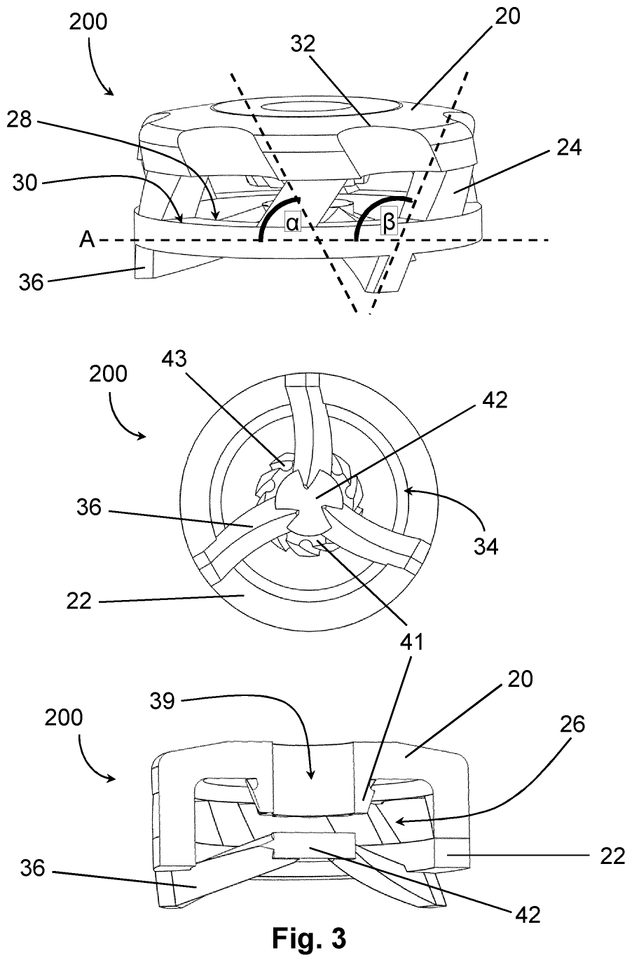

FIG. 3 shows another embodiment of a rotor 200 for use with the first aspect of the invention. The rotor 200 is largely the same as the rotor 100 shown in FIGS. 2a-c, with several variations.

In the embodiment of FIG. 3, the radial blades 36 protrude outwardly from the plane of the base A and are slightly curved. The radial blades 36 are connected to each other by a central hub 42 in the centre of the base 22, which provides structural support to the blades 36.

The second outlets 32 are pitched at an angle α of 60° relative to the plane of the base A, while the dividers 24 and radial blades 36 are pitched at an angle β of 150° relative to the plane of the base A.

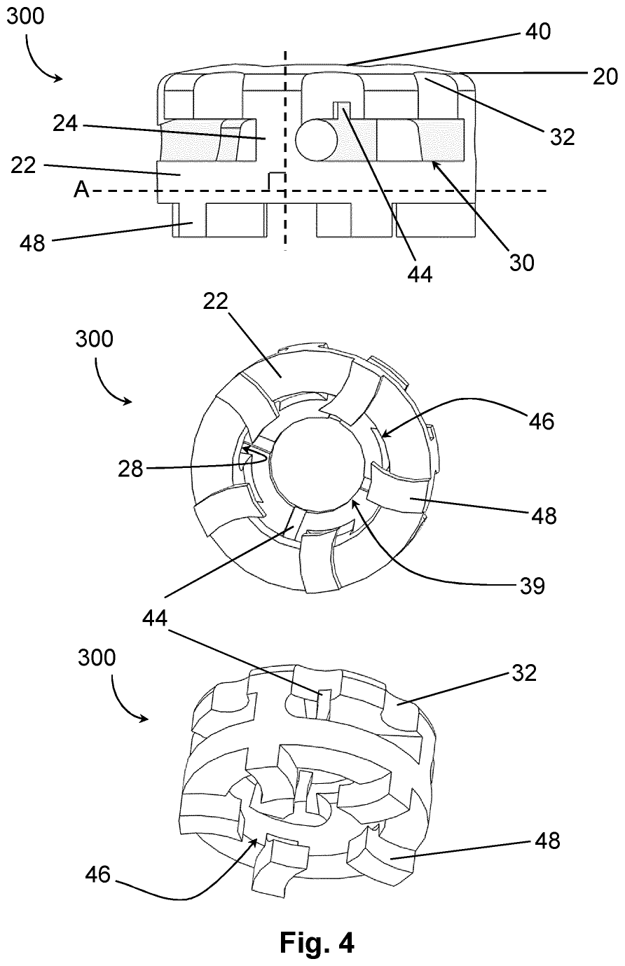

FIG. 4 shows an embodiment of a rotor 300 for use with the second aspect of the invention. Features of the rotor 300 which are shared with the rotors 100, 200 of FIGS. 2-3 are referred to with the same numbers.

The rotor 300 comprises a roof 20 and a base 22, spaced apart by a plurality of dividers 24 (in the illustrated embodiment, four dividers). The dividers 24 extend radially from the periphery of a central chamber 26 defined between the roof 20 and the base 22. The roof 20 and the base 22 are generally disc-shaped.

A passage is defined between each adjacent pair of dividers 24, with each passage having an inlet 28 located radially outward of the central chamber 26 and a first outlet 30 in an outer peripheral surface of the rotor 100. The first outlets direct flow laterally from the rotor. Each passage also has two second outlets 32 in the roof 20. The second outlets 32 direct flow upwardly from the rotor. Therefore, in the illustrated embodiment, the rotor 300 comprises four dividers 24, four passages, four first outlets 30 and eight second outlets 32. Each second outlet 32 is a part-circular cut-out in the roof 20, extending inwardly from the outer periphery of the rotor 100. The dividers 24 and the second outlets 32 are oriented perpendicular to the plane of the roof (which is parallel to the plane of the base A).

The base 22 comprises a central aperture 46 fluidly connected to the central chamber 26. The base 22 further comprises a plurality of radial vanes 48 protruding outwardly from the plane of the base A and arranged around the periphery of the central aperture 46. The radial vanes 48 extend towards the centre of the base 22, projecting partially over the central aperture 46. In the illustrated embodiment, the base 22 comprises five radial blades 46 equally spaced apart around the periphery of the central aperture 46. The radial vanes 46 are curved and are not pitched at an angle relative to the plane of the base A.

The roof 20 comprises four grooves 44 extending between the central chamber 26 and four of the second outlets 32, in an alternating arrangement. The roof 20 also comprises a central bore 39 and engagement means in the form of a hexagonal-shaped cavity 40, which is configured to fit to the end of a hollow shaft having a corresponding size and shape.

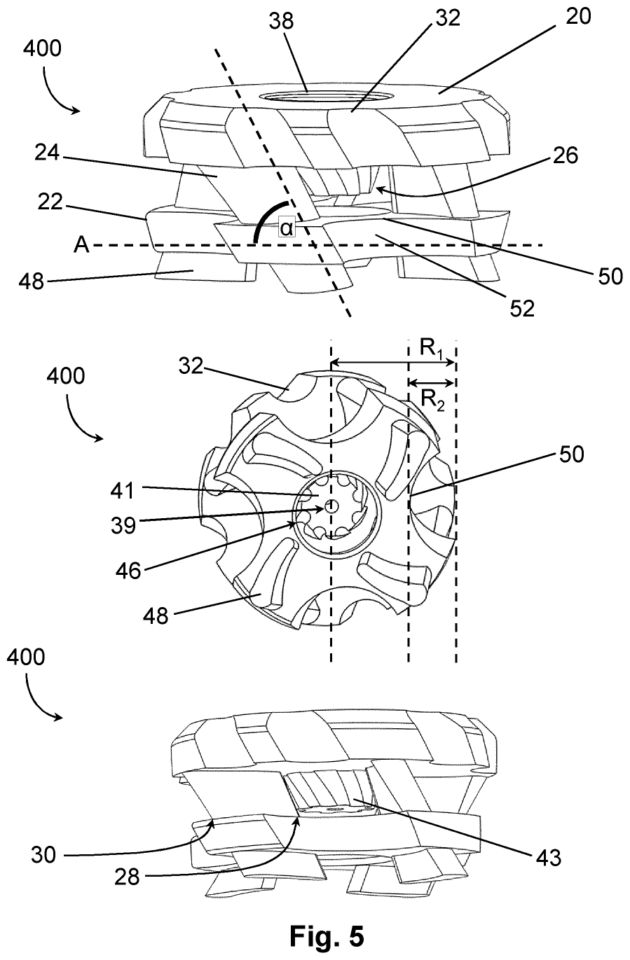

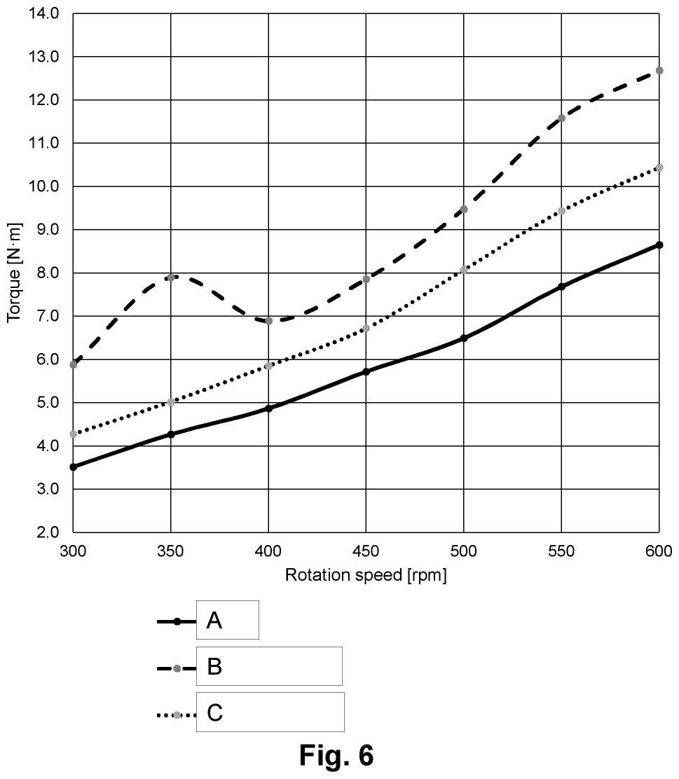

FIG. 5 shows an embodiment of a rotor 400 for use with the third aspect of the invention. Features of the rotor 400 which are shared with the rotors of FIGS. 2-4 are referred to with the same numbers.

The rotor 400 comprises a roof 20 and a base 22, spaced apart by a plurality of dividers 24 (in the illustrated embodiment, four dividers). The dividers 24 are curved and extend radially from the periphery of a central chamber 26 defined between the roof 20 and the base 22. The roof 20 and the base 22 are generally disc-shaped.

A passage is defined between each adjacent pair of dividers 24, with each passage having an inlet 28 located radially outward of the central chamber 26 and a first outlet 30 in an outer peripheral surface of the rotor 100. The first outlets 30 direct flow laterally from the rotor. Each passage also has two second outlets 32 in the roof 20. The second outlets 32 direct flow upwardly from the rotor. In the illustrated embodiment, the rotor 300 comprises four dividers 24, four passages, four first outlets 30 and eight second outlets 32. Each second outlet 32 is a part-circular cut-out in the roof 20, extending inwardly from the outer periphery of the rotor 400.

The base 22 comprises a central aperture 46 fluidly connected to the central chamber 26. The base 22 further comprises a plurality of radial vanes 48 protruding outwardly from the plane of the base A and arranged around the periphery of the central aperture 46. The radial vanes 48 are curved and tapered such that the width of each vane decreases from the outer periphery of the rotor 400 to the central aperture 46. The radial vanes 48 are a continuation of the dividers 24 through the base 22, such that the dividers 24 and the radial vanes 48 form a continuous plane through the base 22.

The roof 20 of the rotor 400 comprises a central bore 39 and engagement means for attachment to a hollow shaft. In the illustrated embodiment, the engagement means comprises a threaded wall 38 for screwing onto the end of the hollow shaft. An inner surface of the roof 20 comprises a flow-directing member for channeling gas bubbles in the roof 20 down into the central chamber 26. In the illustrated embodiment, the flow-directing member comprises an annular wall 41 which extends around the circumference of the central bore 35. The annular wall 41 is tapered such that it is widest at the roof 20 and narrows as it extends towards the base 22. The annular wall 41 comprises a plurality of open channels 43 which extend generally in a direction between the roof 20 and the base 22 and are curved so as to impart a downward spiral flow pattern on bubbles in the roof 20.

The dividers 24, the radial vanes 48 and the second outlets 32 are oriented at an angle α of 60° relative to the plane of the base A (or the plane of the roof, which is parallel to the plane of the base A).

The base 22 comprises a plurality of cut-outs 50 arranged between the radial vanes 48, which extend inwardly from the outer periphery of the rotor 400. In the illustrated embodiment, the base 22 comprises four radial vanes 48 and four cut-outs 50. The cut-outs 50 are part-circular in shape. The cut-outs 50 extend inwardly from the outer periphery of the rotor 400 to a depth R₂ which is approximately 30% of the radius R₁ of the rotor 400.

The edge 52 of each cut-out is pitched at an angle relative to the plane of the base A. The angle of the edge 52 varies such that, at one end, the edge 52 is pitched at an angle of 60° and, at the other end, the edge 52 is pitched at an angle of 150°.

### Full Scale Water Modelling Results

The performance of various rotor designs was tested by water modelling, in a full size crucible fitted with a baffle plate. The crucible was filled with 250 litres of room temperature water to a depth of 700 mm. Water has similar viscosity characteristics to molten aluminium, and is therefore a useful proxy to indicate the performance of a rotor in molten metal.

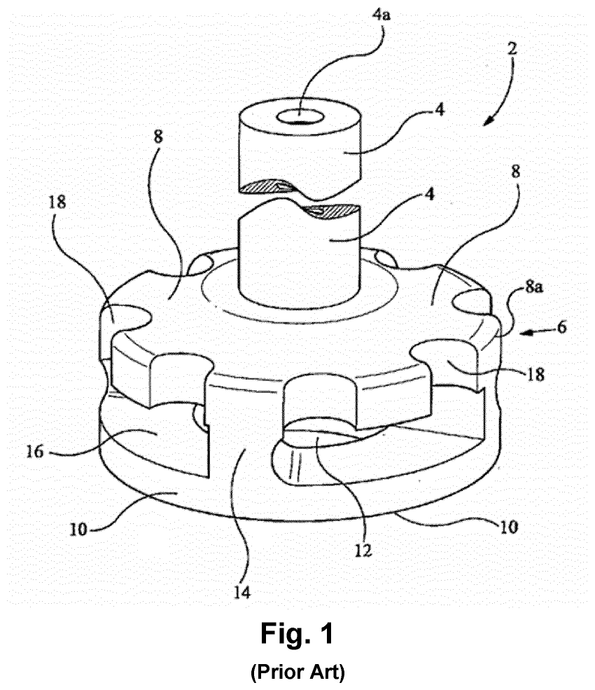

Three rotor designs were compared: (A) a prior art rotor design as shown in FIG. 1, (B) a design according to the invention as shown in FIG. 4, and (C) a design according to the invention as shown in FIGS. 2a-c.

### Stirring Power and Vortex Height

Torque measurements were carried out at different rotation speeds, to compare the relative stirring power of each rotor design. The height of the water in the crucible was also measured, from a baseline of 700 mm. A high water surface level usually indicates the creation of a more powerful vortex. The strength of the vortex needs to be balanced, as a higher vortex can lead to faster degassing and better mixing efficiency, but also increased air entrainment into the melt.

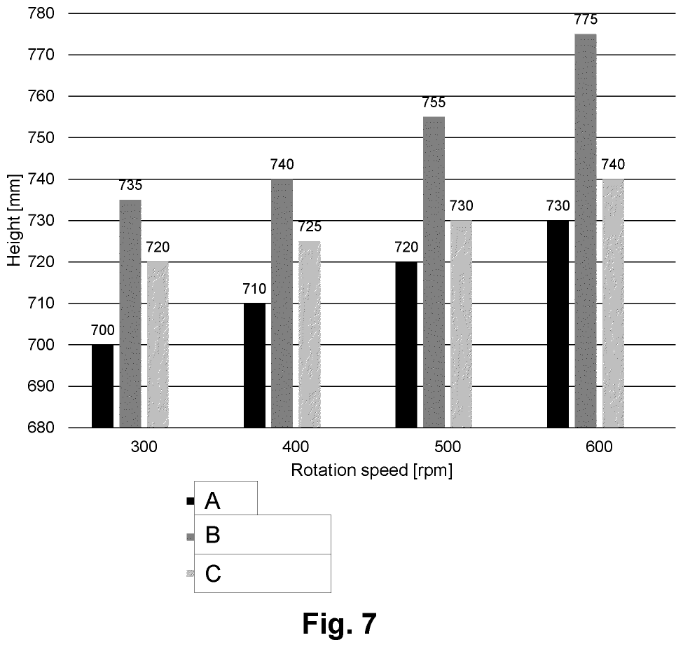

The torque measurement results are shown in FIG. 7, which is a graph of torque (N-m) vs rotation speed (rpm). At all rotation speeds, both rotor designs B and C exhibited higher torque than comparative design A, with design B displaying the highest torque.

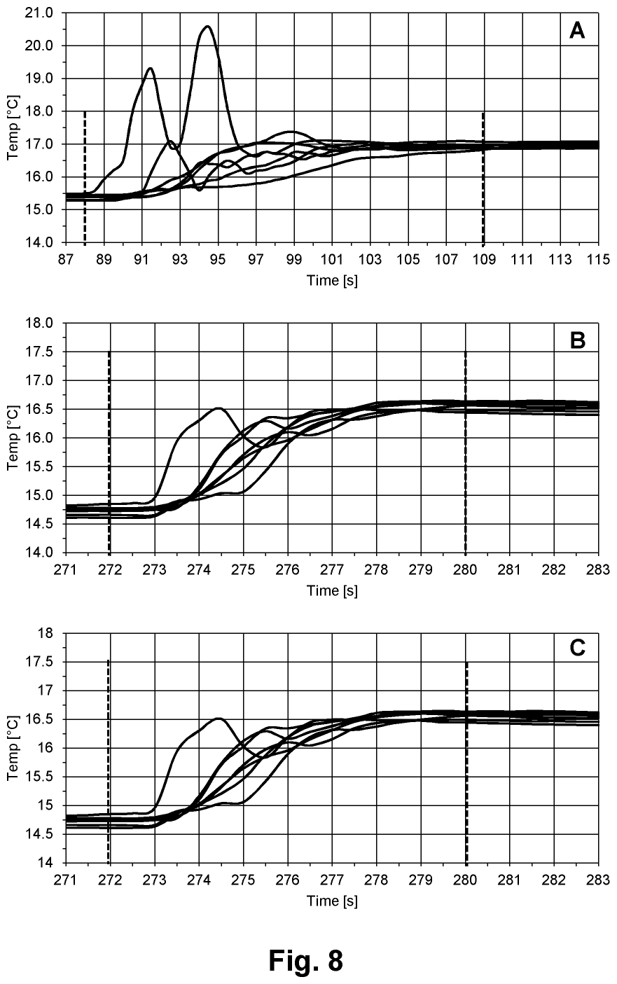

As shown in FIG. 8, the increased torque of design B also resulted in a significantly higher water surface level than either A or C, indicating a more powerful vortex. Design C exhibited a slightly higher water surface level than comparative design A, indicating a slightly more powerful vortex.

### Mixing Efficiency

A series of thermocouples were located at various different locations within the crucible and on the baffle plate to measure the temperature of the water at those locations. The rotor was immersed in the water and equilibrated at a rotation speed of 600 rpm. A 7 litre volume of hot water (80° C.) was then poured into in the crucible, and the time taken for the temperature to re-stabilise across all thermocouples was measured (referred to as the mixing time).

The results are shown graphically in FIG. 8, which are graphs of temperature (° C.) vs time (s). Each line in the graph corresponds to the temperature reading from a different thermocouple in the crucible.

Rotor design A had a mixing time of 109 s-88 s=21 seconds.

Rotor design B had a mixing time of 280 s-272 s=8 seconds

Rotor design C had a mixing time of 280 s-272 s=8 seconds

Rotor designs B and C both exhibited a mixing efficiency of more than twice the mixing efficiency of comparative design A.

### Degassing Efficiency

### Example 1

An oxygen meter was immersed in the water, towards the top of the crucible. The rotor was rotated at 600 rpm and the time taken for the oxygen level to reach a minimum plateau was measured. Oxygen dissolved in water exhibits similar behaviour to hydrogen dissolved in molten aluminium, so this test gives a useful measure of degassing efficiency in molten metal.

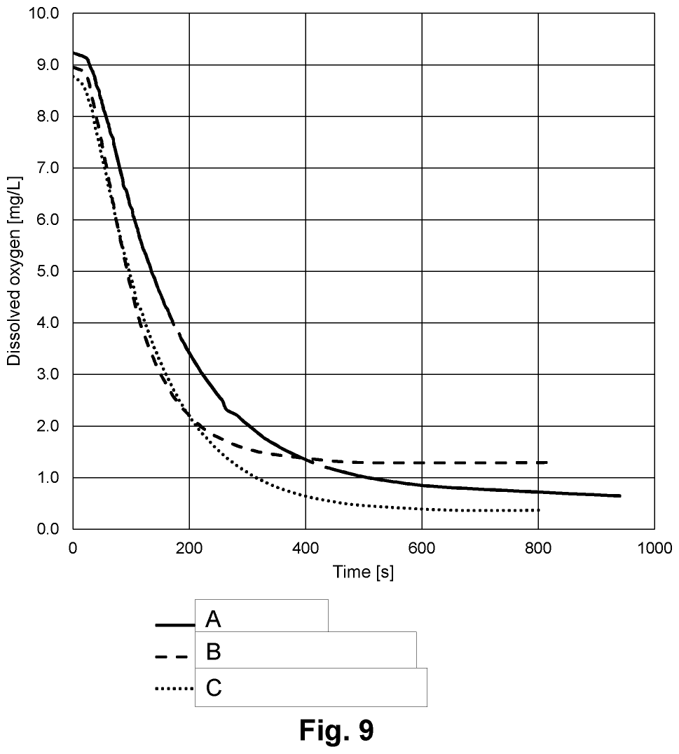

The degassing results are shown in FIG. 9, which is a graph of oxygen level (mg/L) vs time (s). Initially, both rotors B and C exhibited significantly faster oxygen removal than comparative design A. The maximum oxygen removal achieved by rotor B was less than that achieved by rotor A, which is likely due to the higher vortex created by rotor B resulting in air entrainment. However, it should be noted that the vortex level may be decreased by adjusting the baffle depth or number of baffle plates, in order to counteract this negative effect.

Rotor C was the best performing, exhibiting both the fastest oxygen removal and the highest maximum oxygen removal (lowest final level of oxygen).

The degassing efficiency of several other rotor designs was also measured, to compare the effect of different individual features.

### Example 2

Firstly, rotor design A was compared against new rotor design D to compare the effect of the radial vanes protruding outwardly from the base. Rotor D had exactly the same features as rotor B except for the grooves in the roof, which were omitted in rotor D.

Secondly, rotor design A was compared against new rotor design E to compare the effect of the grooves in the roof. Rotor E had exactly the same features as rotor A, but with the addition of grooves in the roof extending between the central chamber and four of the second outlets.

Finally, rotor design B was compared with rotor design D, to demonstrate the synergy of radial vanes and grooves.

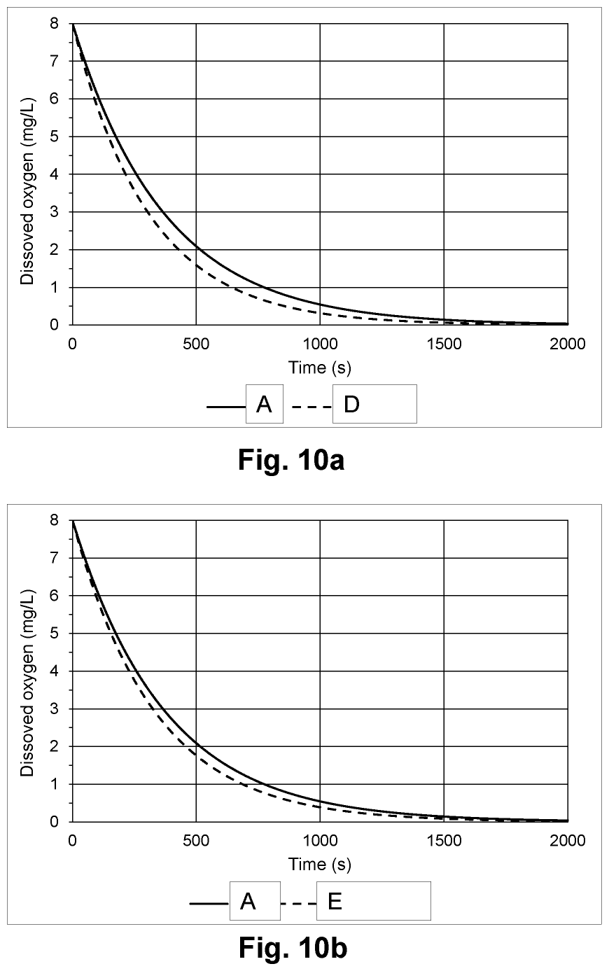

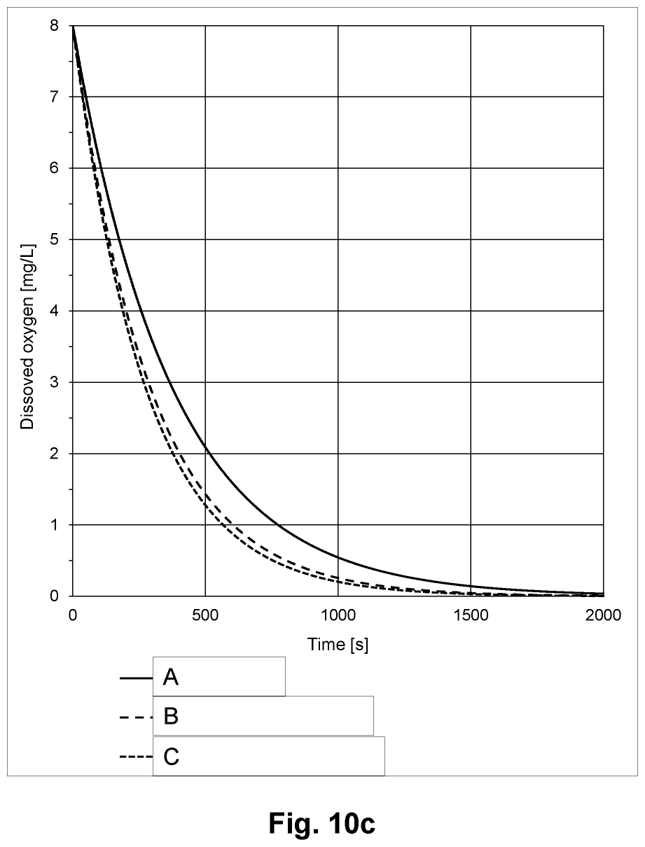

The results are shown in FIGS. 10a-c, which are graphs of oxygen level (mg/L) vs time (s). As shown in FIG. 10a, the radial vanes produce a significant increase in degassing efficiency, while FIG. 10b shows that the grooves in the roof produce a moderate increase in degassing efficiency. FIG. 10c shows that the rotor comprising both radial vanes and grooves achieved the best degassing efficiency.

### Small Scale Water Modelling Results

Further experiments with different rotor designs were carried out on a miniaturised setup, with a 193×300 mm cylindrical tank filled with 20° C. water to a depth of 230 mm (6.73 litres). The rotors were scaled to a common diameter of 65 mm. A baffle in the form of a 400×20 mm strip of aluminium was clamped adjacent to the tank wall. The rotors were mounted to a centrally located laboratory overhead stirrer at a depth of 70 mm above the base of the tank. Gas was supplied into the vicinity of the rotor at either 1.8 L/min (air) or 2 L/min (argon). The oxygen concentration of the water was measured by a YSI optical dissolved oxygen probe submerged in the water.

### Mass Transfer Analysis

Each experiment started by equilibrating water in the tank, which involved purging the tank with air while stirring at high speed (600 rpm) until a stable oxygen concentration of ˜10 mg/L was achieved. For each rotor design, the degassing kinetics were measured at 400, 600 and 800 rpm with a fixed argon flow of 2 L/min.

It is believed that the time varying oxygen concentration in the tank, C(t), will follow Equation 1:

$$C ( t ) = {C}_{∞} + ( {C}_{0} - {C}_{∞} ) exp ( - kt ) \qquad ( 1 )$$

where C₀ is the initial oxygen concentration, C_{∞} is the asymptotic, flat line oxygen concentration achieved at t=∞, and k is the decay constant. Given the known initial concentration, C₀, a non-linear least squares iterative fitting solution is used to determine both C_{∞} and k, by applying the fitting solution to the degassing curve for a rotor.

The boundary layer at the free surface of the water is assumed to maintain local equilibrium with the air above it, maintaining an equilibrium concentration C_{E}. The difference between the equilibrium concentration at the surface C_{E} and the bulk composition C(t) drives a flow of dissolved oxygen from the surface into the bulk, which also depends on the area of the free surface A_{S} and the surface mass transfer coefficient k_{S}. The population of bubbles present in the water also establish a local equilibrium concentration C_{B} at their surfaces, and the difference between the bulk composition C(t) and C_{B} drives a flow of dissolved oxygen to the bubbles which also depends on the surface area of the bubbles A_{B} and the bubble mass transfer coefficient k_{B}. Analysis of the flow of dissolved oxygen from the surface to the bulk and from the bulk to the bubbles leads to Equation 2, which expresses the expected time dependence of the bulk oxygen concentration:

$$C ( t ) = ( \frac{{k}_{2}}{{k}_{1} + {k}_{2}} ) {C}_{E} + [ {C}_{0} - ( \frac{{k}_{2}}{{k}_{1} + {k}_{2}} ) {C}_{E} ] exp ( - \frac{( {k}_{1} + {k}_{2} )}{V} t ) \qquad ( 2 )$$

The two grouped rate constants are k₁=k_{B}A_{B} and k₂=k_{S}A_{S}. The flat line concentration C_{∞} is related to the effective rate constants and the equilibrium oxygen concentration C_{E} by Equation 3:

$${C}_{∞} = ( \frac{{k}_{2}}{{k}_{1} + {k}_{2}} ) {C}_{E} \qquad ( 3 )$$

The fitted rate constant is identified using (k₁+k₂)/V. Therefore, by knowing the tank volume V and the equilibrium oxygen concentration C_{E}, and by measuring the bulk oxygen concentration C(t), the above relationships allow the individual bubble and surface grouped rate constants k₁ and k₂ to be determined.

As described above, the parameter relating to bubble mass transfer, k₁, depends on the rotor's ability to develop a population of small bubbles, where smaller bubbles will have a higher mass transfer and a greater total area of interface with the water. Therefore, the greater k₁ is, the greater the rotor's contribution may be to the rate of degassing. The parameter relating to surface mass transfer, k₂, describes the extent to which the rotor develops near-surface flows and generates up-gassing/out-gassing at the free surface, but also reabsorption of air from the free surface.

Five rotor designs were compared: (A) a prior art rotor design as shown in FIG. 1, (B) a design according to the invention as shown in FIG. 4, (C) a design according to the invention as shown in FIGS. 2a-c, (F) a design according to the invention as shown in FIG. 3, and (G) a design according to the invention as shown in FIG. 5.

### Bubble Mass Transfer Parameter, k₁:

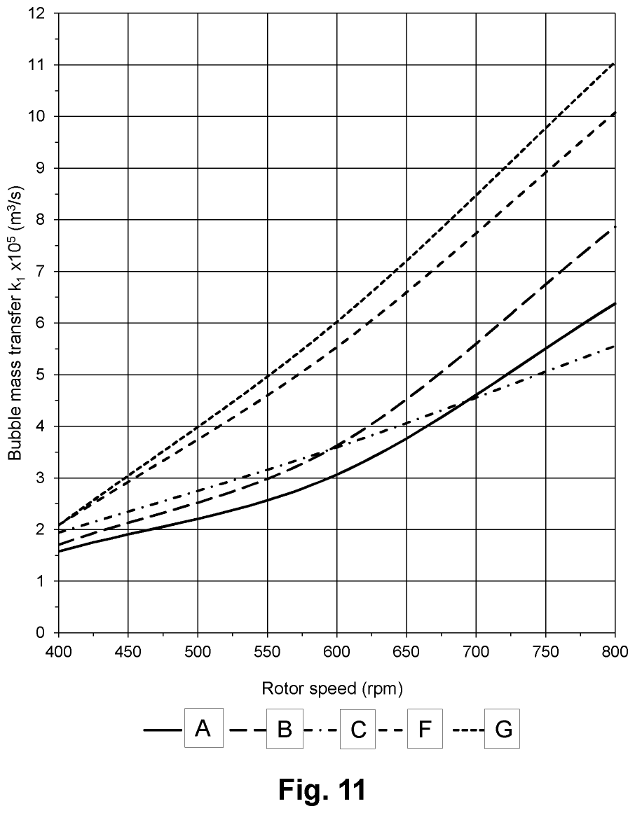

The preceding analysis was applied to the degassing curves for each rotor. The calculated k₁ values for each rotor are presented in Table 1 below and in FIG. 11.

TABLE 1

| | A | B | C | F | G |
|---|---|---|---|---|---|
| 400 rpm | 1.58 | 1.71 | 1.94 | 2.09 | 2.08 |
| 600 rpm | 3.07 | 3.63 | 3.59 | 5.54 | 6.02 |
| 800 rpm | 6.38 | 7.86 | 5.56 | 10.08 | 11.06 |

Each of the rotor designs according to the invention (B, C, F and G) exhibited a higher k₁ value than the prior art example A at stirring speeds of 400 rpm and 600 rpm, which are within the standard range of speeds for stirring aluminium. Rotor designs F and G exhibited the highest k₁ values at all stirring speeds, indicating that these designs are able to produce a greater population of fine bubbles.

### Surface Mass Transfer Parameter, k₂:

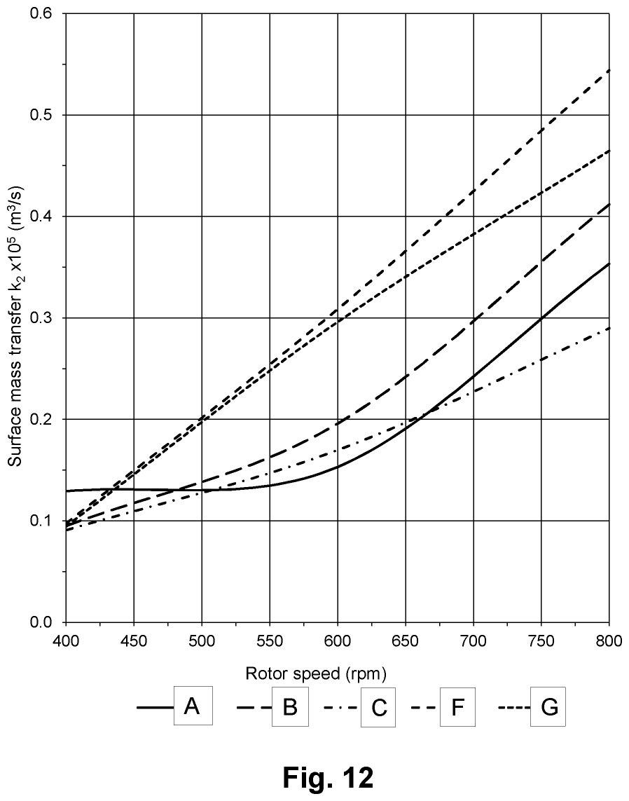

The calculated k₂ values for each rotor are presented in Table 2 below and in FIG. 12.

TABLE 2

| | A | B | C | F | G |
|---|---|---|---|---|---|
| 400 rpm | 0.13 | 0.10 | 0.09 | 0.10 | 0.09 |
| 600 rpm | 0.15 | 0.20 | 0.17 | 0.31 | 0.30 |
| 800 rpm | 0.35 | 0.41 | 0.29 | 0.54 | 0.46 |

The general trend of calculated k₂ values largely mirrors those of the k₁ values, indicating that greater surface mass transfer is generally correlated with greater bubble mass transfer. However, at 400 rpm each of the rotor designs according to the invention (B, C, F and G) exhibited a lower k₂ value than prior art example A, indicating lower up-gassing and lower re-absorption of air from the free surface at this stirring speed.

### Degassing Efficiency

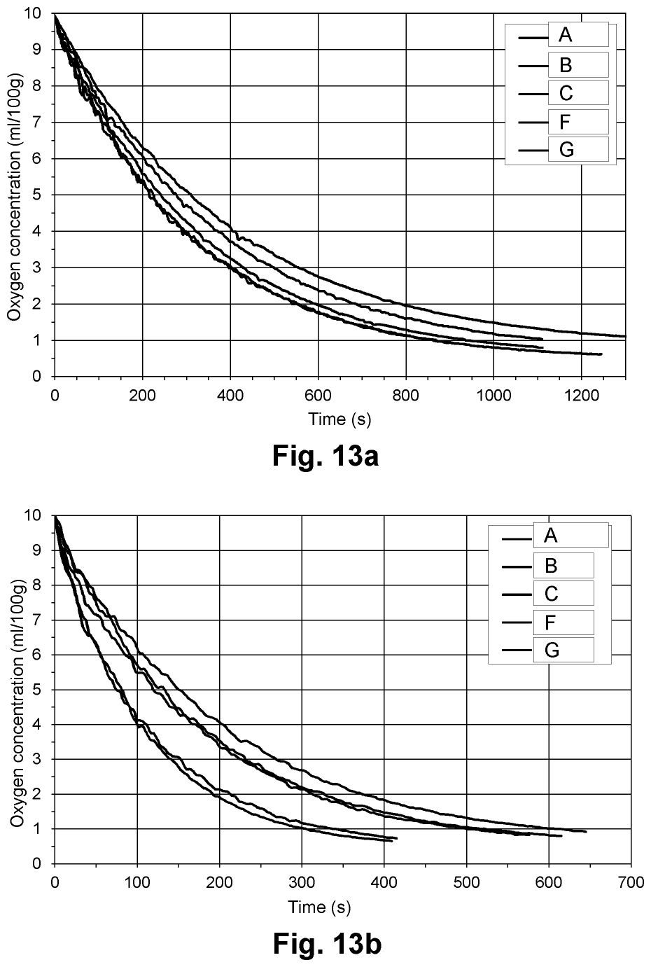

Using the miniaturised setup described above, the five rotor designs A, B, C, F and G were rotated at 400 rpm (FIG. 13a) and at 600 rpm (FIG. 13b). The time taken for the oxygen level to reach a minimum plateau was measured.

All four designs according to the invention (B, C, F and G) showed greater degassing efficiency than prior art design A at both 400 and 600 rpm. Designs F and G showed the best degassing performance at both 400 and 600 rpm, with significantly faster oxygen removal at 600 rpm (approximately 30-50% faster than the prior art design A).

The improved degassing performance of the rotor designs according to the invention also means that, for a set degassing time, a lower rotation speed can be used to achieve the same level of oxygen removal as prior art design A, reducing the amount of power required by the rotary device.

### Aluminium Melt Testing Results

The performance of the rotor design C (according to FIGS. 2a-c) was tested in a full size crucible using molten aluminium and compared to the prior art rotor design A (as shown in FIG. 1).

### Inclusion Removal

Rotor C was immersed in molten aluminium and rotated at 350 rpm for a treatment time of 4 minutes. A Vmet analysis (Vesuvius metal quality analysis) was carried out using a scanning electron microscope and pre-defined selection rules and image processing algorithms. The test was repeated once and the summarised results recorded in Table 3a below. The test was then repeated two further times using rotor design A (FIG. 1) at the higher speed of 500 rpm, and the Vmet analysis carried out and the summarised results recorded in Table 3b.

TABLE 3a

| | Ex 1 | | Ex 2 | |
|---|---|---|---|---|
| Rotor C | Start | End | Start | End |
| Inclusion Index | 30.4 | 7.8 | 64.9 | 14.1 |
| Total Features | 1399 | 683 | 1121 | 575 |
| aluminium oxides | 55 | 24 | 84 | 18 |
| 0.5-15 μm | 52 | 24 | 74 | 16 |
| 15-30 μm | 3 | 0 | 8 | 2 |
| 30-75 μm | 0 | 0 | 2 | 0 |
| >75 μm | 0 | 0 | 0 | 0 |
| other inclusions | 93 | 45 | 68 | 113 |
| 0.5-15 μm | 73 | 42 | 58 | 97 |
| 15-30 μm | 19 | 2 | 9 | 16 |
| 30-75 μm | 1 | 1 | 1 | 0 |
| >75 μm | 0 | 0 | 0 | 0 |

TABLE 3b

| | Ex 3 | | Ex 4 | |
|---|---|---|---|---|
| Rotor A | Start | End | Start | End |
| Inclusion Index | 21.2 | 34.7 | 11.7 | 66.4 |
| Total Features | 1110 | 684 | 822 | 486 |
| Aluminium oxides | 40 | 22 | 46 | 24 |
| 0.5-15 μm | 39 | 22 | 44 | 23 |
| 15-30 μm | 0 | 0 | 1 | 1 |
| 30-75 μm | 1 | 0 | 1 | 0 |
| >75 μm | 0 | 0 | 0 | 0 |
| other inclusions | 33 | 67 | 24 | 162 |
| 0.5-15 μm | 32 | 51 | 23 | 114 |
| 15-30 μm | 0 | 8 | 1 | 33 |
| 30-75 μm | 1 | 7 | 0 | 14 |
| >75 μm | 0 | 1 | 0 | 1 |

The inventors have found that the rotor according to the present invention is surprisingly effective at removing inclusions from the molten aluminium. In examples 1 and 2, the rotor C was found to lead to a drastic reduction in both the inclusion index (derived from the area fraction of the defects present) and in the total number of inclusions in the aluminium. As shown in Examples 3 and 4, although reductions in total inclusions are achievable, this is not supported by an equivalent reduction in the inclusion index. Of particular note is the near total removal of larger inclusions by Rotor C. Table 3a shows that very few inclusions, whether aluminium oxides or otherwise, with a size greater than 15 microns remained after treatment. In contrast, in examples 3 and 4, the number of large inclusions (>15 microns) increased. This tests show that the rotor design C is as effective or better than the prior art rotor design A, and that this is achieved at lower rotational speeds.

The use of lower rotational speeds is desirable since they reduce wear on the rotors and machinery and reduce the size of the vortex which may form at the surface, thus reducing gas entrainment in the molten metal. However, it is typical for higher speeds to be more effective at degassing and inclusion removal due to greater mixing. Thus the selected speed in a processing operation is a balance of these two factors.

### Degassing Efficiency

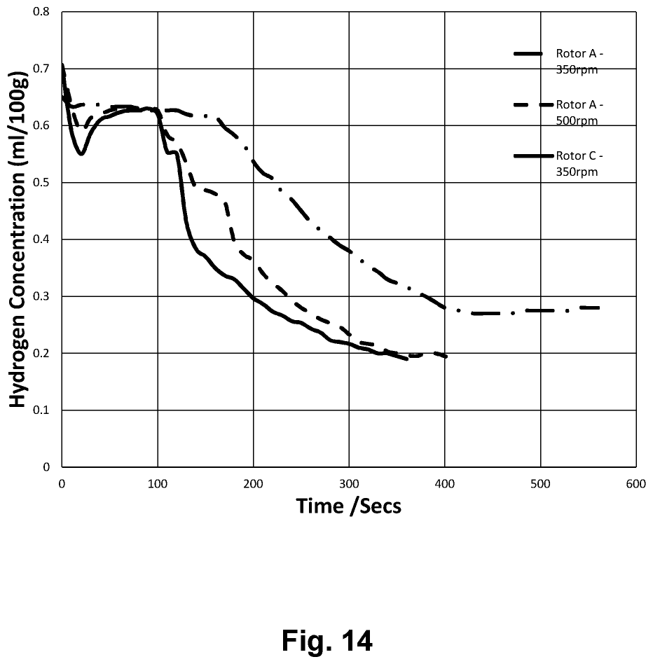

Rotor C was immersed in aluminium and rotated at 350 rpm while the hydrogen content in the molten aluminium was monitored. Nitrogen gas was passed through the rotor to remove hydrogen from the melt. The test was then repeated using Rotor A at 350 and 500 rpm. The results were plotted in the graph in FIG. 14.

The average time for the hydrogen concentration to reduce by 50% was:
Rotor C—350 rpm 160 s
Rotor A—350 rpm 350 s
Rotor A—500 rpm 185 s

The graph shows that the Rotor C is more effective at removing hydrogen from the aluminium melt than the Rotor A at an equal rotational speed, and is still an improvement compared to Rotor A at a greater rotational speed of 500 rpm.

1. A rotary device for treating molten metal, the device comprising a hollow shaft and a rotor at one end of the hollow shaft, the rotor comprising:
a roof and a base, the roof and base being spaced apart and connected by a plurality of dividers;
a central chamber defined between the roof and the base, the dividers extending radially from the periphery of the central chamber;
a passage being defined between each adjacent pair of dividers, each passage having an inlet located radially outward of the central chamber and an outlet in an outer peripheral surface of the rotor; and
a flow path being defined through the hollow shaft into the central chamber, through the inlets of the passages and out of the outlets,
wherein the base comprises a plurality of apertures fluidly connected to the central chamber, and a radial blade defined between each adjacent pair of apertures.

2. The rotary device of claim 1, wherein the base comprises at least three apertures and at least three radial blades.

3. The rotary device of claim 1, wherein the radial blades protrude outwardly from the plane of the base.

4. The rotary device of claim 1, wherein the radial blades are obliquely angled relative to a plane normal to the axis of rotation, and wherein the radial blades are configured to slow fluid entering the central chamber through the base.

5. A rotary device for treating molten metal, the device comprising a hollow shaft and a rotor at one end of the hollow shaft, the rotor comprising:
a roof and a base, the roof and base being spaced apart and connected by a plurality of dividers;
a central chamber defined between the roof and the base;
a passage being defined between each adjacent pair of dividers, each passage having an inlet located radially outward of the central chamber and an outlet in an outer peripheral surface of the rotor; and
a flow path being defined through the hollow shaft into the central chamber, through the inlets of the passages and out of the outlets,
wherein the base comprises a central aperture and a plurality of radial vanes protruding outwardly from the base, the radial vanes being arranged around the periphery of the central aperture, and
wherein the radial vanes extend towards the centre of the base and at least partially over the central aperture.

6. A rotary device for treating molten metal, the device comprising a hollow shaft and a rotor at one end of the hollow shaft, the rotor comprising:
a roof and a base, the roof and base being spaced apart and connected by a plurality of dividers;
a central chamber defined between the roof and the base;
a passage being defined between each adjacent pair of dividers, each passage having an inlet located radially outward of the central chamber and an outlet in an outer peripheral surface of the rotor; and
a flow path being defined through the hollow shaft into the central chamber, through the inlets of the passages and out of the outlets,
wherein the base comprises a central aperture and a plurality of radial vanes protruding outwardly from the base, the radial vanes being arranged around the periphery of the central aperture, and
wherein the base further comprises a plurality of cut-outs arranged between the radial vanes, the cut-outs in the base extending inwardly from the outer periphery of the rotor.

7. The rotary device of claim 6, wherein the cut-outs in the base are part-circular or semi-circular in cross-section.

8. The rotary device of claim 6, wherein the base comprises at least four cut-outs.

9. The rotary device of claim 1, wherein the rotor comprises at least four dividers and at least four passages defined therebetween, or wherein the rotor comprises at least six dividers and at least six passages defined therebetween.

10. The rotary device of claim 1, wherein each passage comprises a second outlet in the roof of the rotor.

11. The rotary device of claim 10, wherein each second outlet is a cut-out extending inwardly from the outer periphery of the roof, and optionally wherein the cut-out is part circular or semi-circular in cross-section.

12. The rotary device of claim 10, wherein an inner surface of the roof comprises a groove extending between the central chamber and at least one second outlet.

13. The rotary device of claim 1, wherein an inner surface of the roof comprises a flow-directing member for channeling gas bubbles in the roof down into the central chamber and towards the base of the rotor.

14. The rotary device of claim 1, wherein the rotor is made from an isostatic pressed refractory material.

15. A rotor for use in the rotary device of claim 1.
